(19) United States
(12) Patent Application Publication
(10) Pub. No.: US 2011/0046996 A1
(43) Pub. Date: Feb. 24, 2011

(54) METHOD FOR DETERMINING THE OPERATING FORECAST FOR A SYSTEM

(75) Inventors: Bruno Foucher, Chatillon Sous Bagneux (FR); Katell Moreau, Paris (FR); Vincent Rouet, Orgeval (FR)

Correspondence Address: RATNERPRESTIA, P.O. BOX 980, VALLEY FORGE, PA, 19482, US

(73) Assignee: European Aeronautic Defence and Space Company EADS France, Paris (FR)

(21) Appl. No.: 12/935,665

(22) PCT Filed: Apr. 1, 2009
(86) PCT No.: PCT/EP09/02378

§ 371 Date: Nov. 8, 2010

(30) Foreign Application Priority Data
Apr. 2, 2008 (FR) 0852171

(51) Int. Cl. G06Q 10/00

(52) U.S. Cl. 705/7

(57) ABSTRACT

According to the invention, to determine an operating forecast for a system, measurements are taken of an environmental value in an environment surrounding the system. Then these measurements are processed in a processing unit in order to determine how much of the system's lifetime has been consumed. The consumed lifetime is based on a history of the system in the environment. This is used to calculate a forecast of a good operating lifetime. According to the invention, this forecast determination is made by adaptive linear regression. Thus, all forecast calculations are simplified and can be performed by the system itself and in real-time.

The object of the present invention is a method for determining the operating forecast for a system, in real time, from an environmental value of this system. The present invention finds particularly advantageous, but nonexclusive, applications in the field of aeronautics, nuclear energy, shipbuilding, car industry, petrochemistry . . . .

An objective of the invention is to optimize the maintenance of a system under monitoring by determining in real time the failure of this system. Another objective of the invention is to embark the monitoring device in the system to be monitored. Another objective of the invention is to determine in real time the lifetime-end forecast for the system under monitoring.

Currently, the diagnosis of a system under monitoring, which in practice is an electronic card, is carried out by a device for recording environmental values. This device is known as Time Stress Measurement Device, TSMD. Such a device is described in the document FR-A1-2 844 902. This device comprises two units. The first unit is embarked in the system to be monitored. And the second unit is located outside the system to be monitored.

The first unit measures in time environmental or factual characteristics of the system to be monitored, such as temperature, moisture, vibrations, shocks . . . . The first unit comprises a memory allowing to record the values of the measured characteristics. After having obtained a complete profile of recorded values, which can last several months, the stored measurements are transferred, in particular in numerical form, into the second unit, which is a central processing unit. The second unit analyzes the recorded values in order to provide a diagnosis for the system. From all these recorded values, the central processing unit extracts information over the consumed lifetime of the system to be monitored.

Failure modes and their impacts are already known. For example, it is known that, with regard to a fatigue, the system is likely to withstand it N times, before breaking down. It is then possible to measure that, when submitted to this fatigue, the system consumed 1/N of its lifetime. For another fatigue, it is likely to withstand it M times, and is thus subjected to a loss of lifetime equal to 1/M. By gradually adding all the lifetime consumptions, or damages, it is possible to know the diagnosis, the general state of fatigue for the system.

In an example, when the system to be monitored is an electronic card embarked in an aircraft, the recorded data are collected and analyzed by the central processing unit only when a complete profile is obtained. For example, a complete profile can be obtained after 350 hours of flight time. Thus, a quite long period of time is observed before transferring the recorded data into the central processing unit. The results provided by the central processing unit are not immediate. Indeed, the quantity of data to be analyzed is so big that several days are necessary before obtaining a percentage of consumed lifetime for the system to be monitored. Consequently, this result regarding the failures of the system under monitoring is not adequate.

With the known type of algorithms, the requirements in calculation resources as well as the requirements in memory resources are relatively considerable. So, the central processing unit cannot be embarked.

Once the operating environment for an electronic component is well known, as well as some operating characteristics for this equipment, it is possible to use a monitoring tool, very similar to TSMD but however with more intelligent functions able to detect predefined critical thresholds and to warn the user. A HUMS (Health and Use Monitoring System) is thus a device which is able, thanks to its diagnosis (generally a brief one), to help the user to maintain his/her equipment.

With a more precise knowledge of the equipment which can be acquired by modeling and simulation operations coupled to real tests, it is possible to optimize a HUMS by providing it with algorithms for specific diagnosis and forecast. This HUMS with advanced functions, also called LAMS (Lifetime Assessment Monitoring System), is able to give, in real time, a percentage of degradation (diagnosis). Moreover, by analyzing the evolution in time of this degradation, a lifetime-end prediction of the electronic component (forecast) can also be given.

Currently, diagnosis and forecast systems and methods function by monitoring specific parameters and predefined thresholds, as described in the document US2006/0271255A1. As improvement, they are based on calculations utilizing, for the diagnosis, the physics of the failure as described in the document WO2007085756. Thus, the forecast corresponds here to an estimation of the number of days of remaining life for an electronic component.

The problem to be solved is thus, knowing the diagnosis of a system, in particular of an embarked system, to establish a forecast, to give a lifetime-end date, preferably a careful one (thus at a date anterior to a real lifetime end), and thus to generate an alarm well before the present time becomes higher than this forecast. In contrast, the HUMS signals only the crossing of the critical threshold, when it can be too late because the system under monitoring will not be maintained before a long time.

The calculation of the lifetime end, the calculation of a forecast, from a diagnosis, is subjected to the same problems as the calculation of the diagnosis. It cannot be embarked, the required calculation resources, in processor size, in calculation times, in power supply are not compatible with the current standards, in particular regarding aircrafts for which the weight of an additional equipment is severely controlled.

In the invention, it is possible to provide the three functions TSMD, HUMS and LAMS with a embarked software in the program memory of the system itself to be monitored. So, this system can also carry out, inter alia, the measurement of its temperature, of its relative humidity, as well as of shocks (three-axis accelerometer) and of vibrations to which it is subjected. In a current version, it is possible to connect sensor modules in great number (250 today, but this number are extensible), in particular for low frequency measurement channels, i.e. for temperature, relative humidity, pressure.

In its present version, the monitoring system of the invention is physically accessible to allow the transfer of the recorded data into a memory card. However, a wireless solution (for example a Zigbee connection has already been tested) can be installed. In this case, the management of the sleep mode as well as of the awakening of a RF (Radio Frequency) module can be defined according to the monitoring application in order to optimize the consumption of energy.

The tool programmed in TSMD must be configured before starting its monitoring. The only information necessary to its operation are the various frequencies of measurement for each sensor. It is possible to implement this information directly in the operating system of the TSMD and to elaborate a configuration by default corresponding to a particular application. In this case, it is enough to place the TSMD and the sensor modules as close as possible to the elements to be monitored, to supply the unit, and to start the monitoring. It is also possible to download this information before beginning the monitoring, but this implies the connection of the TSMD to a microcomputer via a serial connection cable.

It is possible to store 1 megabit of data in four nonvolatile memories of 6 kilobits each. These memories can be discharged at the end of the monitoring mission with the help of a microcomputer, of a serial connection cable if there is no RF module, and of the application already mentioned above. The use of a bigger, removable and nonvolatile memory of MMC type is also possible.

The estimation of the state of degradation of an electronic component can be based on the in-situ monitoring of its environment which allows the calculation of the associated damages. The tool programmed in HUMS can emit warnings if thresholds not to be exceeded has been configured. Lastly, tools are able to carry out, in real time, the simplification of the data (with a minimal threshold of taking into account) and to identify cycles of fatigue. It is thus possible to record only the simplified profiles, and even only the identified cycles characterized by their amplitude, their average and their duration. “Cycle of fatigue” means for example cycles of temperature, as those submitted to an aircraft which takes off, which arrives in upper atmosphere, at very low temperature, then which lands. But the method according to the invention is not limited to the measurement of cycle of fatigue. It can relate to all other fatigues for which one can measure a corresponding consumption of lifetime.

According to the invention, the diagnosis and the embarked forecast, and in real time, were developed according to a specific methodology. For example, for each identified cycle, a unit damage can be allocated while referring to a matrix containing the results of simulation (or of experiment returns). The sum of these unit damages allows to obtain an estimation of the health, and thus a diagnosis, of the electronic system under monitoring. The successive rounding-off operations in calculations can lead to locate the diagnosis between an optimistic value and a pessimistic value. Of course, when the electronic system is subjected to several mechanisms of failure, the associated damages are cumulated in order to take into account their interactions.

Whereas TSMD and HUMS already exist, the invention relates to the development and the integration of the function LAMS. According to the aforementioned, the calculation of the diagnosis (which can be a percentage of damage, for example) can allow, by studying its evolution in time, to estimate the date of failure for the monitored system. To do so, several methods exist: the linear regression, the Autoregression Integrated Moving Average (ARIMA) model, the decomposition of the time series. However, these techniques of statistical forecast are not particularly relevant or adapted to embarked calculation in real time (due to few calculation resources). For example, the ARIMA model, although it is particularly effective, requires to identify a lot of delays and the coefficients which should be used, and is too demanding in term of resources. As for the linear regression, it can appear completely false since the evolution is not linear. And it appears from experiments that the evolution of the diagnosis is seldom linear in real environment.

To solve this problem, in the invention, one chose to carry out a linear regression, but a piecewise one. Then, the result obtained is a simple method that can be embarked and that has non nonlinearities. In practice, the pieces can be determined by measuring the coefficient of linear correlation. As soon as it is superior to a threshold, another piece is then created. Or the pieces have a fixed length, for example every 100 measurements, each measurement being carried out once per minute. The various pieces, put end to end, allow then, in the prolongation of the last piece, to establish a realistic forecast quickly. Moreover, it is done in time real as a new forecast is established for each new piece.

Thus, the object of the invention is a method for determining the operating forecast for a system in which
measurements of an environmental value in an environment surrounding the system are carried out,
these measurements are processed in a central processing unit in order to determine a lifetime consumed by the system,
this consumed lifetime resulting from a history of the system in the environment, and
a lifetime forecast for a correct operation is deduced, characterized in that
the forecast is deduced by using a piecewise linear regression.

The invention will be better understood from the following description and from the annexed figures. Those figures are only an indicative, and by no means limitative, illustration of the invention. The figures show:

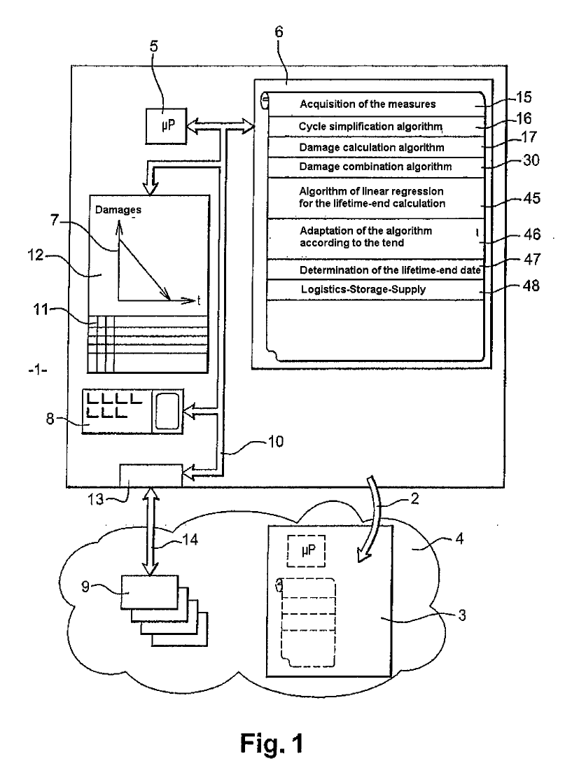

FIG. 1: a schematic representation of a device implementing the method according to the invention;

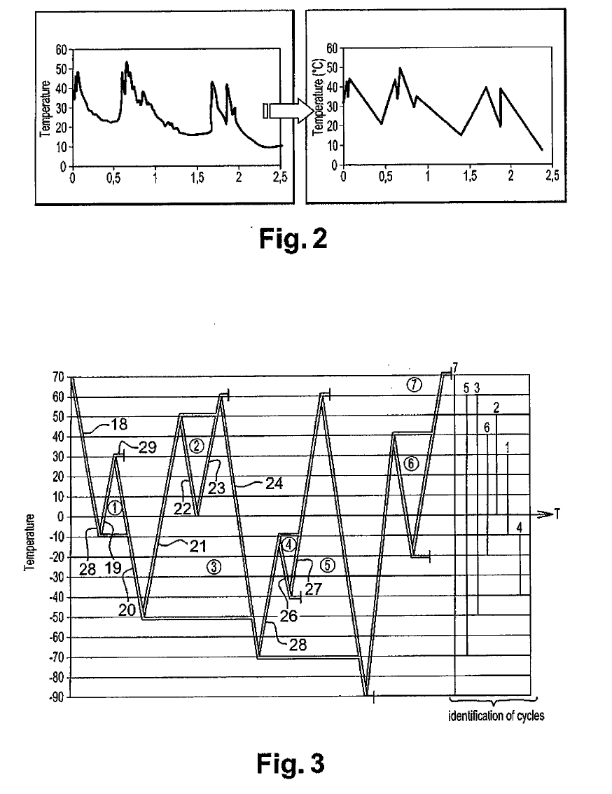

FIGS. 2 and 3: diagrams of the acquisition of measurements, of the simplification of the measurements, and the calculation and acquisition of cycles of life for a system monitored with the method according to the invention;

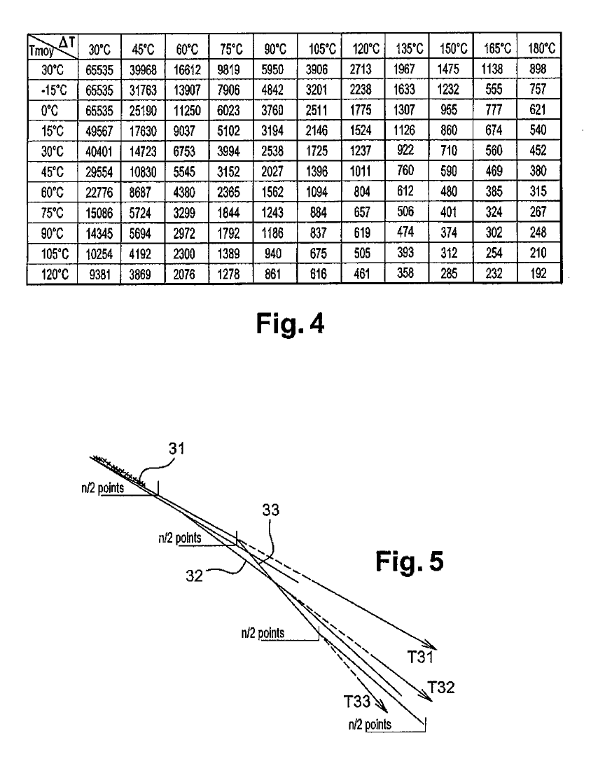

FIG. 4: a table of lifetime consumption attached to the life cycles represented in FIGS. 2 and 3;

FIG. 5: an representation of a calculation of the various linear regressions;

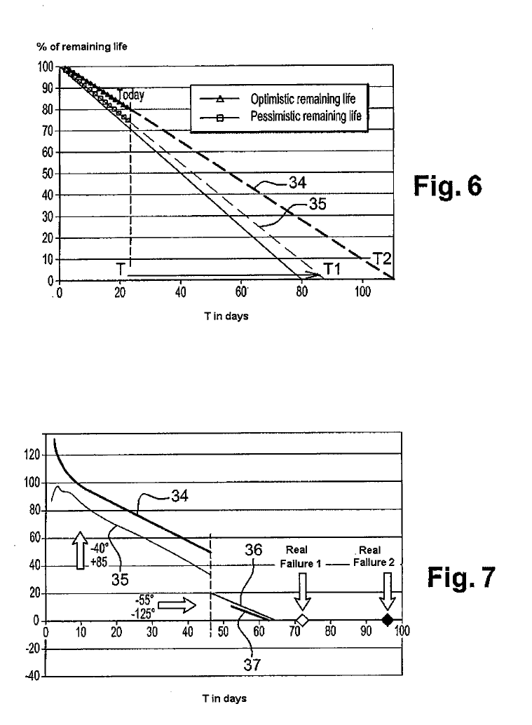

FIG. 6: an example of a diagnosis and an associated forecast, between a pessimistic value T1 and an optimistic value T2, at an instant T;

FIG. 7: the evolution of a lifetime-end forecast for a system under monitoring;

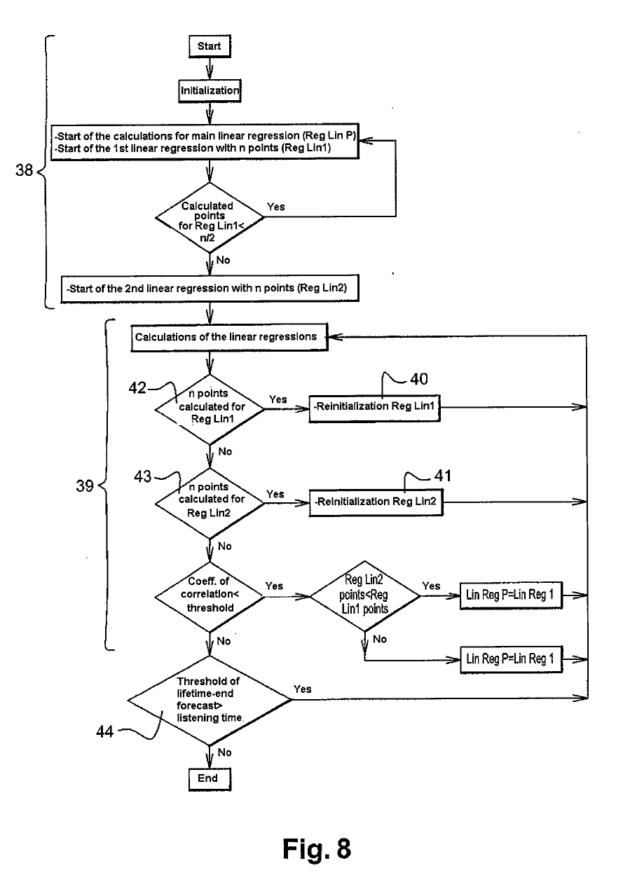

FIG. 8: an algorithm of lifetime-end forecast in real time according to an embarked embodiment;

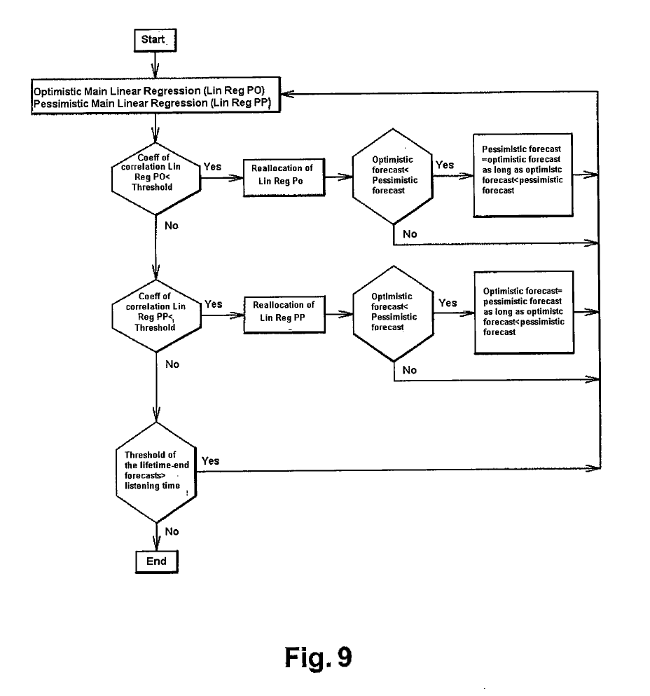

FIG. 9: an improvement of the preceding algorithm showing the integration of the simultaneous optimistic and pessimistic forecasts.

FIG. 1 is a schematic representation of a device 1 implementing the method according to the invention. The device 1 allows to carry out a monitoring in real time. It is preferably embarked 2 in a system 3 to be monitored. The device 1 is an embarked autonomous intelligence allowing to diagnose the health of the system 3. In an example, the system 3 to be monitored is an electronic card embarked in an aircraft. In the invention, the monitoring device 1 measures and analyzes in an instantaneous way a value of an environmental characteristic of an environment 4 of the system 3. In an example, the measured and analyzed environmental value is a temperature of the system 3. In particular, one measures the temperature of the brazing joints on an electronic card in the system 3.

So, the device 1 monitors the thermal cycles to which the electronic card is subjected. For example, in the case of an aircraft, these cycles are those to which parts of the aircraft are subjected at very low temperatures, for example −40° C., and at very high temperatures, at the ground level in full desert under the sun, for example at +85° C. Of course, other types of environmental characteristics such as in particular moisture, pressure, shocks can be measured.

The device 1, and thus the device 3, are often carried out in the form of a integrated circuit. It comprises a central processing unit. This central processing unit comprises a microprocessor 5 and a program memory 6. The microprocessor 5 is connected to the program memory 6, to a data memory 7, to a keyboard/screen 8 (optionally) and to at least one sensor 9 via a bus of internal communication. The memory 7 comprises an area 11 containing for example a matrix of cycles with failures M and an area 12 containing forecast information. The device 1 is connected to the sensor 9 via an interface 13 connected to the bus 10 and to an external bus 14 connected to all the sensors. The system 3 is of the same type. Either the device 1 is embarked in the system 3, or it is outside it.

In a variant, the central processing unit 1 is embarked in the system 3 without being integrated therein, as it is the case in FIG. 1.

The device 1 is supplied in energy by an autonomous battery, not represented. This battery is preferably rechargeable. When the battery is to be changed, before the destruction of the system 3 to be monitored, the data concerning the consumed lifetime can be stored in a nonvolatile memory.

The device 1 generates, via the In/Out interface 10, measurement instructions to the sensor 9. The device 1 receives via this interface the measurement carried out by the sensor 9. The sensor 9 measures a value of an environmental characteristic 4. It transmits this measurement to the microprocessor 5 in the form of electric signals via the buses 14 and 10. In an example, the sensor 9 is a temperature sensor.

The sensor 9 can be replaced by other types of existing sensors. According to the various embodiments of the invention, the device 1 can comprise as many sensors 9 as it is necessary to implement the application. The sensor 9 can be located on the system 3 to be monitored.

The program memory 6 is divided into several areas, each area corresponding to instructions for fulfilling a function of the device 1. Thus, an area comprises instructions for the acquisition of the measurements carried out by the sensor 9. In this respect, the left part in FIG. 2 shows the acquisition of temperature values according to time. An area 16 comprises instructions for applying, for each acquired measurement, a data simplification algorithm in order to determine extreme values more easily. Typically, the measurements in the left part in FIG. 2 are smoothed so as to obtain the measurements shown in the right part. The simplified, smoothed profile consists of successive minimum and maximum peaks. This simplified profile can be obtained by using a low-pass filter with a predefined filtering threshold. The device considers that two consecutive extreme values form a half-cycle. Preferably, the area 16 comprises all the processing operations disclosed in the document WO2007085756.

An area 17 comprises instructions for applying, for each determined extreme value, a cycle counting algorithm in order to determine a thermal cycle to which the system 3 is subjected and, by reading the table in FIG. 4, to produce the consumed lifetimes for the system 3, from the determined cycles. The estimation of this consumed lifetime is carried out by reading the area 11 in the memory containing the matrix of cycles with failures in FIG. 3 which is obtained by simulation or experiment return. For each determined cycle, the device determines a value of damage.

The cycle counting algorithm comprises three parameters: one parameter of temperature difference ΔT between two extreme values forming a half-cycle, an average temperature of the half-cycle Tmoy, and a ramp time or half-cycle duration, tramp.

The cycle counting algorithm is a recursive function. Consequently, for the needs in real time as well as in RAM memory size, three circular buffers, one for each parameter, are used to store the half-cycles. In a preferred embodiment, these three buffers can store up to ten consecutive half-cycles. The size of these buffers can be adjusted according to the application.

Tests carried out on many profiles of temperature allow to highlight an optimal output of the cycle counting algorithm, when using a buffer with a depth of ten half-cycles. Indeed, no half-cycle has been lost when using such buffers.

To determine a cycle, the algorithm 16 checks whether the two following conditions are fulfilled. The first condition relates to the fact that at least two half-cycles are stored in the buffer. The second condition relates to the fact that a difference of temperature ΔT for a new half-cycle is higher than that of a preceding half-cycle. The difference of temperature ΔT is the absolute value of the difference of temperature for the detected extreme values, forming the half-cycle. For example, half-cycles 18 to 27 are represented in FIG. 3. The algorithm 16 calculates that the difference of temperature for the second half-cycle 19 is lower than the difference of temperature for the third half-cycle. In this case, the second half-cycle 19 is counted as a cycle. The extreme values 28 and 29 of the second half-cycle are consequently suppressed.

The consumed lifetime is then calculated, for each new residual cycle or half-cycle, with the help of the relation by reading the table 11 visible in FIG. 4, by extracting for each temperature cycle an average temperature Tmoy and a difference ΔT. This reading allows to convert each determined cycle into a value of damage equal to the inverse of the number of cycles with failures corresponding to a fatigue of this type. It carries out a cumulation of these values of damage. This cumulation can comprise the taking into account, by instructions loaded in a storage area 30 in the memory 6, FIG. 1, of a combination of damages of various natures, coming from various types of environment (moisture, pressure, . . . . ). This cumulation is transmitted to a comparator. This comparator receives at a second entry a predefined threshold of maximum damage for the system 3. As soon as the cumulation of the values of damage is higher than the threshold, the device 1 generates a warning, allowing to optimize the maintenance of the system. This warning can be the setting off of an audible and/or visual alarm and/or the sending of a message to an operator. This message can be transmitted by means of wireless communication protocols, such as those of the standard UMTS or the standard GSM, or Zigbee, etc. . . .

According to the invention, a simple opportunist observation of a threshold crossing is no satisfactory. One prefers to calculate a lifetime forecast (for example a number of operating days before failure). The experience shows that the simple extrapolation of the damage cumulation, related to the service time of the system 3 since its startup, is not precise enough. For example, as multiple systems are likely to be replaced in an aircraft, on different dates, and as aircrafts are stopped for inspections, known as of type A, only every 350 hours of flight time (according to the type of aircraft), it is appropriate to know this forecast with precision in order to organize at best the preventive replacements.

A linear regression, in FIG. 5, consists in determining, from a scatter of points of measurement, a straight line of equation y=ax+b, for estimating the values a and b and quantifying the validity of this relation thanks to the coefficient of linear correlation. In this case, the points plotted on the diagram in FIG. 5 represent, according to time, at the present time and progressively, the health of the system 3. Thus, from one measurement to another, the health can only drop, but it drops more or less according to the harshness of the cycle or the fatigue which justified it. If the cycle were mild, for example between −40° C. and +85° C., the damage will be weak, in any case less strongly than if the cycle were harsh, for example between −55° C. and +1° C. In the graphs in FIGS. 5 and 6, time is laid off as abscissa and health resulting from the cumulated damages laid off as ordinate.

Thus, to try a linear regression amounts firstly to search the straight line D the equation of which is y=ax+b and which extends as close as possible to the points. “To extend as close as possible”, according to the method of least squares, means to make minimal the sum of the squares of the deviations of the points relative to the straight line. One can also search the straight line the equation of which x=a′y+b′ and which makes minimal the comparable sum. Obviously, one wishes to come upon the same straight line. It will be the case if and only if a′=1/A. The quantity aa′ is called the coefficient of linear correlation between x and y. In practice, its absolute value is seldom equal to 1, but it is generally estimated that the adjustment is valid as soon as this coefficient has an absolute value higher than √ 3/2. In the invention, this coefficient of correlation can be useful, with a preferred value of 98%, to determine the length of the pieces.

However, preferably, the measurements can be regularly counted, until reaching N measurements, for example n is worth 200, and one calculates a straight line 31 of linear regression, in FIG. 5. Simultaneously, one can calculate, by extending this straight line 31, a lifetime forecast T31. In the invention, one takes into account the evolution of this straight line for a following group of n measurements maximum. Either the n following measurements lead to the same straight line, or they modify it. The modified straight line could also provide, by extending it, a lifetime-end forecast. However, as the phenomenon is not linear, the proposition would not be right.

Consequently, one prefers to calculate a new segment of straight line 32 from the new group of measurements. As improvement, whereas one calculates the straight lines 31 and 32 from a maximum of n measurements, the n measurements, taken into account each time, are not necessarily independent. One can choose on the contrary to carry out this calculation every n/2 measurement, by taking each time only n/2 new measurements associated to n/2 old measurements directly preceding them. The calculations of the linear regressions limited to n points are carried out permanently and not only until reaching the n points. Preferably, it is only when crossing the threshold of the coefficient of correlation of the main linear regression that a reallocation is carried out: it is re-initialized with the limited linear regression which has the most points (between n/2 and n).

It is noted, from FIG. 5, that the straight line 31 gives a (favorable) forecast T31, whereas the straight line 32 gives a less favorable forecast T32. When the acquisition of the fourth sub-group of n/2 measurements is over, it appears that the algorithm of the invention replaces the straight line 32, and its forecast T32, by a straight line 33, and a even less favorable forecast T33. And so on, the forecast evolves in time, from T31 to T33, and this information is put at maintenance operators' disposal in order that these operators take it into account for carrying out the preventive replacements. For example, a forecast at five days distance implies the preventive replacement of a system 3 under monitoring if, at the time of an inspection of the type A, one knows that the next inspection of the type A will be carried out after 350 hours of flight time.

FIG. 6 shows an example of a diagnosis and a forecast between a pessimistic value and an optimistic value at a moment T as well as their respective associated forecasts T1 and T2. The adaptive linear regression method that has been developed allows the taking into account of the optimistic and pessimistic environmental variations. The optimistic evaluation 34, in the case of the temperature measurements, does not take into account the half-cycles suppressed during the processing, whereas the pessimistic method takes into account all possible fatigues. In parallel, three conventional linear regressions are thus calculated. The main linear regression is calculated from T0 and as long as the coefficient of correlation is higher than a defined threshold (0.98 for example). The two other linear regressions will be calculated with a maximum of n points (200 for example): the first 31 points starting from T0, the second 32 points after n/2 points of measurement, and so on. Their calculation is actualized for each new measurement and re-initialized every n measurements. When the coefficient of correlation of the main linear regression becomes lower than the threshold, this linear regression takes then immediately the value of the linear regression having the most points (including between n/2 and n) between the two linear regressions limited to n points. Thus, the main linear regression takes into account the last events which have occurred and allows, by extrapolation, a better lifetime-end forecast (a number of days in a preferred example).

When the calculation of the diagnosis is comprised between two minimal and maximum values, it is necessary to double the number of linear regressions. FIG. 7 shows an example of the evolution in time of the values T1 and T2 for an electronic system 3 for which one searches to provide the lifetime-end forecast. The forecast corresponds to the intersection of the straight line, resulting from the main linear regression, with the X-axis (durations) for a lifetime end planned with 1000 of damage. However, in order to plan a preventive maintenance, this threshold of 100% can be defined with a lower rate of damages according to the knowledge of the system under monitoring, for example 60%. In this case, the provided forecasts represented by T1 and T2 will be given by the intersection of the straight lines, resulting from the main linear regressions, with the straight lines Y=40% of remaining life, FIG. 6.

According to FIG. 7, in the case of a double forecast (optimistic and pessimistic), and if a reallocation of the main linear regression occurs (detection of the crossing of a threshold of correlation) in either calculation, then the optimistic/pessimistic coherence will be preserved, if necessary by allocating the same value to the linear regression which will not have been subjected yet to this reallocation, for example, in FIG. 7, from day 46 to day 53. FIG. 7 also shows that, due to a change in exposure conditions, from −40° C./+85° C. to −55° C./+1° C., the adaptive calculation according to the invention allows to replace optimistic and pessimistic curves 34 and 35 by two new curves 36 and 37, providing a forecast at 65 days distance much less favorable than the expected forecast at 75 days distance. Thus, with the invention, one measures a trend, at the present time, of the evolution of the consumed lifetime, and one deduces, at the present time, a corrected forecast of consumed lifetime. The experience showed that, for two monitored systems, the failures occurred respectively at 70 days and 97 days distance, on a date ulterior to that finally calculated by the forecast.

FIGS. 8 and 9 show the algorithms implemented in the invention for calculating the lifetime-end forecast of a system 3 under monitoring. The algorithm in FIG. 9 is only a duplication of the algorithm in FIG. 8, applied if optimistic and pessimistic calculations are carried out. The algorithm in FIG. 8 comprises, in a conventional way, an initialization 38. It also comprises calculations 39 of a main linear regression and of two linear regressions limited to n measurements and shifted temporally by n/2 measurements. The limited linear regressions are re-initialized, 40 and 41, each time a new group of n points of measurements has been taken into account. The calculation of the piecewise linear regressions are based on the steps 40 and 41 following the test steps 42 and 43, respectively. A test 44 measures that the lifetime-end forecast is higher at the present time, or on a forthcoming date of inspection of the type A, B, C or D, to produce a piece of information for a replacement.

According to the algorithm in FIG. 9, the operation of the algorithm in FIG. 8 is carried out twice: once for the optimistic evaluation and once for the pessimistic evaluation. Thus, one measures two forecasts, an optimistic forecast and a pessimistic forecast, the real forecast being located between these two forecasts.

The memory 6, in FIG. 1, thus comprises areas 45 to 47 where functions 38, 39 and 44 of the algorithms in FIG. 8 and in FIG. 9 are stored respectively. It also comprises an area 48 used as an operating system, as a managing system for the measurements, the supply, and possibly the transmission of the results.

1. Method for determining the operating forecast for a system comprising:
measuring an environmental value in an environment surrounding the system,
processing the measurements in a central processing unit in order to determine an amount of damage of the system, wherein the
damage results from a history of the system in the environment, and
estimating a lifetime forecast for a correct operation,
by using a piecewise linear regression of the damage determined from the history of the system in the environment.

2. Method according to claim 1, further comprising:
calculating a trend, at the present time, of a consumed-life evolution, and
forecasting a corrected lifetime forecast for an operation until failure is deduced at a present time.

3. Method according to claim 2, wherein the trend is measured by using an adaptive numerical regression.

4. Method according to claim 3, wherein
estimating the lifetime forecast includes applying the linear regression to all damage points since a last initialization.

5. Method according to claim 4, further including
calculating a new trend in parallel with a maximum of n points every n/2 points, where n is a positive integer.

6. Method according to claim 3, further including:
calculating a first trend, and
calculating a second trend with a set of no more than n sliding points where n is a positive integer and re-initializing the first trend by allocating the second trend to the first trend if a coefficient of correlation of the first trend goes down below a predefined threshold.

7. Method according to claim 1, further including
determining two forecasts, an optimistic forecast and a pessimistic forecast, wherein a real forecast is located between the optimistic and pessimistic forecasts.

8. Method according to claim 1, wherein the step of measuring comprises,
measuring a temperature, brazing joints on an electronic card of the monitored system.
